(19) United States
(12) Patent Application Publication
(10) Pub. No.: US 2026/0100436 A1
(43) Pub. Date: Apr. 9, 2026

(54) METHOD OF RECOVERING METAL FROM BATTERY WASTE

(71) Applicant: Nanyang Technological University, Singapore (SG)

(72) Inventors: Vivek VERMA, Singapore (SG); Yi CAI, Singapore (SG); Madhavi SRINIVASAN, Singapore (SG)

(21) Appl. No.: 19/348,643

(22) Filed: Oct. 2, 2025

(30) Foreign Application Priority Data
Oct. 3, 2024 (SG) 10202403081Q

(51) Int. Cl. H01M 10/54; C01G 53/502; C01G 53/82; C22B 3/00; C22B 3/44; C22B 7/00; C22B 47/00

(52) U.S. Cl. CPC H01M 10/54; C01G 53/502; C01G 53/82; C22B 3/44; C22B 7/007; C22B 23/0469; C22B 47/00; C01P 2002/72; C01P 2006/40

(57) ABSTRACT

A method of recovering metal from battery waste is provided. The method includes providing a battery waste leachate comprising metal ions and sulphate ions in an acidic medium, contacting the battery waste leachate with a reagent comprising ammonium ions to precipitate the metal ions as a double sulphate salt having formula (NH₄)₂M(SO₄)₂·6H₂O, wherein M is one or more of Ni, Mn and Co, heating the precipitate at a temperature of 400° C. or more to form an anhydrous precipitate, dissolving the anhydrous precipitate in a solution comprising sulphate ions and crystallizing MSO₄·6H₂O from the resultant solution.

### CROSS-REFERENCE TO RELATED APPLICATION

This application claims the benefit of priority to Singapore patent application Ser. No. 10202403081Q filed Oct. 3, 2024, the content of which is hereby incorporated by reference in its entirety for all purposes.

### TECHNICAL FIELD

Various embodiments relate to a method of recovering metal from battery waste.

### BACKGROUND

Due to increasing use of lithium (Li) ion batteries and resultant increase in waste from spent lithium ion batteries, recycling the metals used in lithium ion batteries are expected to reduce burden on mining metal industry, and reduce loss of crucial metals ending up in the landfills.

Among the crucial metals found in spent lithium ion batteries, nickel (Ni) and cobalt (Co) are two of the most crucial metals that can be recovered. At this time, nickel-rich batteries are widely used and are of mainly two types, 1) Nickel Manganese Cobalt (NMC) batteries, with nickel being present in the highest amount, followed by cobalt and manganese transition metal, and 2) Nickel Cobalt Aluminum (NCA) batteries, with nickel being present in the highest amount, followed by cobalt and some aluminum. Consequently, a major part of battery waste is rich in nickel, followed by cobalt and other metals.

The battery waste may be crushed, grinded and sieved to obtain a black colour powder containing these metals or metal compounds, along with organic components such as graphite. The black colour powder is otherwise termed or known as black mass.

In recycling of spent lithium ion batteries, attempts have been made to recover metals such as nickel and cobalt from black mass. Most attempts start with dissolving the metals in an acid. The organics are then filtered out, leaving the metals in the acid solution. The acid solution containing the metals is termed the leachate. From this leachate containing the metals, attempts have been made to recover nickel, manganese and cobalt as their hydroxide and/or oxalate/carbonate salts.

From the battery manufacturing perspective, nickel and cobalt are mostly used in their sulphate salt forms for synthesizing battery cathode materials including NMC and NCA type batteries discussed above. Sulphate salts are used due to their low cost as compared to other forms. More importantly, sulphate salts are water soluble, which makes them ideal for co-precipitation, which is the most popular technique of battery cathode synthesis.

In co-precipitation, sulphate salts of Ni, Co and/or Mn are dissolved in water to form a sulphate mixture, which is then used to obtain mixed hydroxide and/or oxalate/carbonate salts of Ni—Mn—Co as a precipitate. The mixed hydroxide and/or oxalate/carbonate salts of Ni—Mn—Co may not possess required or desired characteristics of particle size distribution, tap density, shape, and homogeneity, which may in turn be detrimental to battery performance of the final cathode material.

As can be seen from the above discussion, two main problems exist. Firstly, their use case is limited if the mixed hydroxide and/or oxalate/carbonate salts do not meet the characteristics required such as particle size distribution, tap density and chemical homogeneity. Secondly, in case these benchmark requirements are not met, the precipitate has to be re-dissolved in strong acid and then converted to water-soluble salts such as sulphates to provide more flexibility in terms of how they may be processed. However, this involves extra cost, resources and energy.

An alternative may be to obtain them as sulphates or sulphate mixtures from the battery waste containing leachate. As with sulphate salts or sulphate mixtures, which are the starting materials for industrial manufacturing of batteries, directly obtaining metal sulphates or metal sulphate mixtures has been difficult due to their very high salt solubilities in water. Although solvent extraction with crystallization methods can be used to get sulphate salts or mixed-sulphate salts, the cost, energy, and time are high for this route.

In light of the above, there exists a need for improved methods to recycle battery wastes that address or at least alleviate one or more of the above-mentioned problems.

### SUMMARY

A method of recovering metal from battery waste is provided. The method may comprise providing a battery waste leachate comprising metal ions and sulphate ions in an acidic medium, contacting the battery waste leachate with a reagent comprising ammonium ions to precipitate the metal ions as a double sulphate salt having formula (NH₄)₂M(SO₄)₂·₆H₂O, wherein M is one or more of Ni, Mn and Co, heating the precipitate at a temperature of 400° C. or more to form an anhydrous precipitate, dissolving the anhydrous precipitate in a solution comprising sulphate ions and crystallizing MSO₄·6H₂O from the resultant solution.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1 is a schematic diagram illustrating a process 100 for manufacturing lithium-ion batteries and recycling Ni, Mn, and Co metals from spent batteries.

FIG. 2A is a graph 200 depicting salt solubilities of Ni 222, Co 224, Mn 226 and copper (Cu) 228 as its hydrated sulphate salt (MSO₄) 225 and as its double salt with ammonia (NH₄-M double sulphate) 227, whereby M=Ni, Co, Mn, or Cu. Y-axis 221 denotes solubility g/100 g water; x-axis 223 denotes Metals.

FIG. 2B is a graph 250 providing comparison of Ni salt as Ni sulphate 235 and ammonium double sulphate (Ni—NH₄ double sulphate) 237 in water 232 and 4M sulphuric acid 234. Y-axis 231 denotes Ni solubility g/100 g water; x-axis 233 denotes medium.

FIG. 3 is a schematic diagram of an overview of a recipe 300 disclosed herein according to an embodiment.

FIG. 4 is a schematic diagram depicting a process 100 of making lithium ion batteries and recycling Ni/Mn/Co metals in spent lithium ion batteries, reproduced from FIG. 1.

FIG. 5 is a flow diagram 500 comparing a double salt sulphate recovery route 504 disclosed herein with a conventional precipitation recipe route 502.

FIG. 6A is a photograph of precipitated double salt sulphate after drying. Scale bar denotes 1 cm.

FIG. 6B is a X-ray diffraction pattern 600 for the double salt sulphate recovered 605 and comparison with the double salt sulphate of Ni, Co, and Mn as reported in the literature ((NH₄)₂Ni(SO₄)₂·6H₂O 607, (NH₄)₂Co(SO₄)₂·6H₂O 609, and (NH₄)₂Mn(SO₄)₂·6H₂O 611). Y-axis 601 denotes intensity (a.u.); x-axis 603 denotes 2θ (degree).

FIG. 7A is a graph 700 showing metal ion concentrations in the leachate solution, before double salt sulphate precipitation 711 and after double salt sulphate precipitation 713, along with % metal recovered/crystallized as solid 715, for Ni 722, Mn 724, Co 726, Li 728, Cu 730, Al 732, and Fe 734. Primary Y-axis 701 denotes solution concentration g/L; x-axis 703 denotes metal; secondary Y-axis 705 denotes recovery/crystallization %.

FIG. 7B is a graph 750 showing rough estimate in percentage of the metal ion distribution between the double salt precipitate as solid 719, and in the leftover solution as raffinate 717, for Ni 772, Mn 774, Co 776, Li 778, Cu 780, Fe 782, and Al 784. Y-axis 741 denotes % metal; x-axis 743 denotes metal.

FIG. 8A is a graph 800 showing Thermogravimetric Data Analysis showing that the double salt sulphate ((NH₄)₂SO₄·MSO₄·6H₂O, M=Ni/Mn/Co) (point 813) converts to anhydrous metal sulphate (MSO₄) at temperatures near 400° C. (point 811). Y-axis 801 denotes weight percent (%); x-axis 803 denotes temperature (° C.). Scan rate 815 is 5° C./min.

FIG. 8B is a photograph of double salt sulphate calcined at 400° C. for 8 hours to give anhydrous metal sulphate. Scale bar denotes 1 cm.

FIG. 8C shows X-ray diffraction pattern 850 of the calcined double salt sulphate 821 and its comparison with anhydrous sulphate salts of Ni, Co, and Mn (anhydrous NiSO₄ 823, anhydrous CoSO₄ 825, and anhydrous MnSO₄ 827). Y-axis 841 denotes intensity (a.u.); x-axis 843 denotes 2θ (degree).

FIG. 9A shows Ni—Mn—Co salt as hydrated sulphate crystals form.

FIG. 9B shows X-ray diffraction pattern 900 of the recovered product hydrated sulphate crystals 921, and its comparison with commercial sulphate salts of Ni and Co(commercial NiSO₄ 923, commercial CoSO₄ 927). The X-ray diffraction pattern of some of the related sulphate salts of Ni and Co is also depicted (NiSO₄·6H₂O 925, CoSO₄·6H₂O 929, CoSO₄·7H₂O 931). Y-axis 901 denotes intensity (a.u.); x-axis 903 denotes 2θ (degree).

FIG. 10 depicts X-ray diffraction fingerprint 1000 of the hydrated sulphate crystals obtained. Y-axis 1001 denotes intensity (a.u.); x-axis 1003 denotes 2θ (degree).

### DETAILED DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

As disclosed herein, a method of recovering metal from battery waste is provided. The method may involve formation of double sulphate salts from battery waste containing metal ions such as nickel, manganese and cobalt. The double sulphate salts may contain univalent cations of ammonium, and divalent cations of nickel, manganese, and/or cobalt. Due to lower solubility of the double sulphate salts in water, as compared to sulphate salts such as nickel sulphate or cobalt sulphate formed in state-of-the-art precipitation methods, there may be greater ease of recovery of the metal ions in the form of precipitate from the battery waste. Consequently, recovery rates for metals such as nickel, manganese and/or cobalt from the battery waste may be higher or improved as compared to conventional methods.

It has been demonstrated in embodiments disclosed herein that formation of double sulphate salt is possible in leachates containing all three metals of Ni, Mn and Co from battery waste recycling processes. The double sulphate salts may be obtained in a much shorter time, as compared to the over 40 hours required in conventional methods, resulting in time and cost savings. This also compares favorably to conventional solvent extraction methods to get sulphates, which involve high cost, energy, and time.

Impurities that may be present in the leachates may be removed, so that Ni, Mn and/or Co that remain in solution may be used for forming double sulphate salt. Advantageously, ammonium sulphate groups, which are undesirable for battery cathode synthesis, may be removed using methods disclosed herein. As such, the double sulphate salt obtained may already be in a usable form that can be directly used in battery cathode synthesis. There may also be improvement over conventional precipitation methods whereby insoluble co-precipitated products may not give rise to the desirable characteristics.

With the above in mind, a method of recovering metal from battery waste is disclosed herein. The term “batteries” may refer to electrochemical cells or batteries containing Ni, Co, and/or Mn. Example of batteries may include lithium-ion batteries, such as those used in energy storage systems, electric vehicles, or various electronic devices such as mobility devices, laptops, tablets, mobile phones, and cordless power tools. The term “battery waste” may refer accordingly to waste generated in the process of manufacturing batteries and/or disposing of batteries, and may include spent batteries such as spent lithium-ion batteries, damaged or expired batteries, prototype batteries, and/or batteries which do not pass specifications for usage.

The term “recovering metal” as used herein may refer to regaining or getting back the metal for reuse.

Methods disclosed herein may comprise providing a battery waste leachate comprising metal ions and sulphate ions in an acidic medium. As used herein, the term “battery waste leachate” may refer to a liquid containing substances such as metal ions which are extracted or leached from battery waste.

Providing the battery waste leachate may comprise contacting a battery waste with sulphuric acid to leach metal ions from the battery waste to form the battery waste leachate. In so doing, metals such as Ni, Mn, Co, Cu, Li, Al, and Fe that may be present in the battery waste may be dissolved in the sulphuric acid, and be oxidized to form metal ions such as Ni²⁺, Mn²⁺, Co²⁺, Cu²⁺, Li⁺, Al³⁺, and Fe³⁺ in the battery waste leachate.

In some embodiments, the battery waste leachate comprises metal ions of Ni²⁺, Mn²⁺, Co²⁺, and SO₄²⁻ ions in an acidic medium formed from contacting sulphuric acid with the battery waste.

The sulphuric acid may be used alone or be provided with hydrogen peroxide. As a mixture of the sulphuric acid and the hydrogen peroxide may act as a strong oxidizing agent, providing the sulphuric acid with the hydrogen peroxide may advantageously allow improved extraction of metal ions from the battery waste.

Solid to liquid ratio of the battery waste with sulphuric acid and hydrogen peroxide may be in the range of 20 g/L to 150 g/L, such as 20 g/L to 120 g/L, 20 g/L to 100 g/L, 20 g/L to 80 g/L, 20 g/L to 60 g/L, 20 g/L to 40 g/L, 50 g/L to 120 g/L, 70 g/L to 120 g/L, 90 g/L to 120 g/L, 50 g/L to 100 g/L, 60 g/L to 90 g/L, or 25 g/L to 40 g/L. In some embodiments, solid to liquid ratio of the battery waste with sulphuric acid and hydrogen peroxide may be in the range of 25 g/L to 40 g/L.

In addition to, or apart from the above, providing the battery waste leachate may comprise contacting a battery waste with a leaching solution to leach metal ions from the battery waste to form a leachate comprising the metal ions, and adding sulphuric acid to the leachate to form the battery waste leachate. This may allow leaching solutions which do not contain sulphates to be used, and the sulphate ions may be added later on when sulphuric acid is added to the leachate.

The leaching solution may, for example, comprise a bioleachate obtainable from a bioleaching process. Examples of bioleachate may include, but not limited to, Acidithiobacillus ferrooxidans or Aspergillus niger, which may be capable of leaching metals from battery waste.

Providing the battery waste leachate may further comprise adding a cementation metal selected from the group consisting of aluminum (Al), iron (Fe), cobalt (Co), and nickel (Ni) to the battery waste leachate, and filtering the resultant battery waste leachate to remove precipitate.

As used herein, the term “cementation” may refer to a process by which a metal is precipitated in metallic form from a solution by using a metal or metal compound that is more reactive. In embodiments disclosed herein, the metal to be precipitated in metallic form may be Cu, and the metal that is more reactive, termed herein as “cementation metal”, may be selected from the group consisting of aluminum (Al), iron (Fe), cobalt (Co), and nickel (Ni).

The cementation metal may be in any suitable form, such as metal powder or metal foil. The cementation metal may dissolve in the battery leachate and selectively displace Cu from the battery leachate, such that Cu may be precipitated out as a metallic form for filtering. In so doing, Cu that may be present in the battery leachate may be removed, and this may be carried out before formation of double sulphate salt to reduce Cu content in the battery leachate.

The method may comprise contacting the battery waste leachate with a reagent comprising ammonium ions to precipitate the metal ions as a double sulphate salt having formula (NH₄)₂M(SO₄)₂·6H₂O, wherein M is one or more of Ni, Mn and Co.

The double sulphate salt may otherwise be termed herein as a double salt, Tutton salt or a Tutton double sulphate salt, and the formula (NH₄)₂M(SO₄)₂·6H₂O may otherwise be expressed as (NH₄)₂[M(H₂O)₆](SO₄)₂, or (NH₄)₂SO₄·MSO₄·6H₂O. The double sulphate salts may be in the form of a blue solid, and/or may contain cations of NH₄⁺, which is a univalent cation, and M²⁺, which represents one or more divalent cations of Ni, Mn and Co, crystallized in the same regular ionic lattice. Advantageously, by varying composition of the divalent cations, properties of the double sulphate salt, such as solubility and thermochemical properties, may be varied.

In various embodiments, M is Ni, Mn and Co. Accordingly, there may be mixed occupancy of Ni, Mn and Co in the divalent cation sites, and the double sulphate salt may be denoted as (NH₄)₂(Ni, Mn, Co)(SO₄)₂·6H₂O.

In various embodiments, M is two of Ni, Mn and Co. Accordingly, there may be mixed occupancy of Ni and Mn, Ni and Co, or Mn and Co in the divalent cation sites, and the double sulphate salt may be denoted as (NH₄)₂(Ni, Mn)(SO₄)₂·6H₂O, (NH₄)₂(Ni, Co)(SO₄)₂·6H₂O, and (NH₄)₂(Mn, Co)(SO₄)₂·6H₂O, respectively.

In various embodiments, M is Ni, Mn or Co. Accordingly, there is single occupancy of Ni, Mn or Co in the divalent cation sites, and the double sulphate salt may be denoted as (NH₄)₂Ni (SO₄)₂·6H₂O, (NH₄)₂Mn(SO₄)₂·6H₂O, or (NH₄)₂Co(SO₄)₂·6H₂O, respectively.

The precipitate that is formed from contacting the battery waste leachate with the reagent comprising ammonium ions may contain one or more of the above-mentioned double sulphate salts. In other words, the precipitate may be a mixture of (NH₄)₂(Ni, Mn, Co)(SO₄)₂·6H₂O, (NH₄)₂(Ni, Mn)(SO₄)₂·6H₂O, (NH₄)₂(Ni, Co)(SO₄)₂·6H₂O, (NH₄)₂(Mn, Co)(SO₄)₂·6H₂O, (NH₄)₂Ni (SO₄)₂·6H₂O, (NH₄)₂Mn(SO₄)₂·6H₂O, and/or (NH₄)₂Co(SO₄)₂·6H₂O.

The reagent comprising ammonium ions may be selected from the group consisting of ammonium sulphate, ammonium hydrogen sulphate, and ammonia solution.

In various embodiments, the reagent comprising ammonium ions is ammonium sulphate. The contacting may be carried out with the ammonium sulphate at an atomic ratio of ammonium ion to metal ion in the range from 2:1 to 20:1, such as 5:1 to 20:1, 10:1 to 20:1, 15:1 to 20:1, 2:1 to 15:1, 2:1 to 10:1, 2:1 to 5:1, 5:1 to 15:1, or 8:1 to 12:1.

In some instances, the contacting may be carried out with the ammonium sulphate at a concentration of 0.4 g/mL of the battery waste leachate.

Contacting the battery waste leachate with the reagent comprising ammonium ions may be carried out at any suitable temperature, such as a temperature in the range from 2° C. to 60° C., such as a temperature in the range from 10° C. to 60° C., 15° C. to 60° C., 20° C. to 60° C., 25° C. to 60° C., 30° C. to 60° C., 35° C. to 60° C., 40° C. to 60° C., 45° C. to 60° C., 50° C. to 60° C., 55° C. to 60° C., 2° C. to 50° C., 2° C. to 40° C., 2° C. to 50° C., 2° C. to 40° C., 2° C. to 30° C., 2° C. to 20° C., 2° C. to 10° C., 20° C. to 50° C., 30° C. to 40° C., or 40° C. to 60° C.

Advantageously, contacting the battery waste leachate with the reagent comprising ammonium ions may be carried out at room temperature and ambient conditions, defined herein as a temperature in the range of 15° C. to 40° C. and at atmospheric pressure. This may mean that external heating or cooling is not required for the contacting to take place.

The method may further comprise separating the precipitate that is formed. This may be carried out by methods such as filtration and/or centrifugation. The resultant solution after separation may be rich in lithium, aluminum and iron.

The method may comprise heating the precipitate at a temperature of 400° C. or more to form an anhydrous precipitate. The anhydrous precipitate may be in the form of a pale yellow powder. The heating, otherwise be termed herein as annealing or calcining, may be carried out to remove ammonium sulphate that may be present in the precipitate. This may in turn mean that it is removed from the double sulphate salt, which may allow the double sulphate salt to be used directly in battery cathode manufacturing, as mentioned above.

Heating the precipitate may be carried out for 5 hours or more, such as 6 hours or more, 7 hours or more, 8 hours or more, or a suitable time to derive the anhydrous precipitate as a pale yellow powder.

As mentioned above, the double sulphate salt may contain one or more of Ni, Co, and Mn. The Ni, Co, and Mn may be present at 85 wt % or more, such as 90 wt % or more, or 95 wt % or more of metal content in the anhydrous precipitate.

The method may comprise dissolving the anhydrous precipitate in a solution comprising sulphate ions and crystallizing MSO₄·6H₂O from the resultant solution. In dissolving the anhydrous precipitate in the solution comprising sulphate ions, a dark green or dark brown solution may be formed. The MSO₄·6H₂O crystalized from the solution may be in the form of bluish green crystals.

In various embodiments, the solution comprising sulphate ions is dilute sulphuric acid.

The MSO₄·6H₂O may comprise NiSO₄·6H₂O, CoSO₄·6H₂O and/or MnSO₄·6H₂O. In various embodiments, the MSO₄·6H₂O comprises NiSO₄·6H₂O, CoSO₄·6H₂O and MnSO₄·6H₂O. Recovery rate of the MnSO₄·6H₂O may be selectively optimized, with highest demonstrated recovery rate of 81%.

The method may further comprise directly using the crystallized MSO₄·6H₂O in a process for manufacturing a battery cathode.

For example, M may be Ni, Mn and Co. Directly using the crystallized MSO₄·6H₂O may comprise dissolving the crystallized MSO₄·6H₂O in water to form a mixed sulphate solution, and reacting the mixed sulphate solution with a precipitating agent to form a precipitate comprising Ni, Mn and Co.

Examples of precipitating agents may include, but are not limited to, i) a hydroxide base selected from sodium hydroxide, potassium hydroxide, lithium hydroxide, and aqueous ammonia; (ii) a carbonate or bicarbonate selected from sodium carbonate, potassium carbonate, ammonium carbonate, sodium bicarbonate, and ammonium bicarbonate; (iii) an oxalate selected from ammonium oxalate, sodium oxalate, and potassium oxalate; (iv) mixed systems such as ammonia/sodium hydroxide, ammonia/ammonium carbonate, and ammonia/ammonium bicarbonate.

In various embodiments, the precipitating agent may be a mixture of ammonia solution with sodium hydroxide, and reacting the mixed sulphate solution with the precipitating agent may form nickel cobalt manganese hydroxide particles.

The method may further comprise adding a lithium salt to the nickel cobalt manganese hydroxide particles to form a NMC cathode.

In various embodiments, the precipitating agent is a mixture of ammonia solution with one or more of an oxalate salt and a carbonate salt. The mixture of ammonia solution with one or more of an oxalate salt and a carbonate salt may, for example, comprise ammonium oxalate and/or ammonium carbonate. Reacting the mixed sulphate solution with the precipitating agent may form a precipitate comprising one or both of nickel cobalt manganese oxalate and nickel cobalt manganese carbonate.

The method may further comprise adding a lithium salt to the precipitate comprising one or both of nickel cobalt manganese oxalate and nickel cobalt manganese carbonate to form a NMC cathode.

In various embodiments, the method may further comprise dissolving the crystallized MSO₄·6H₂O in water to form an electrolyte, and carrying out electrowinning on the electrolyte to deposit one or both of Ni and Co on an electrode.

The term “electrowinning” as used herein may refer to a process whereby a metal is transferred from an electrolyte solution to an electrode, such as electrodeposition of metals from a solution to an electrode. The electrowinning process may be conducted in an acidic sulphate electrolyte with a certain pH range such as about 2 to 6, at moderate temperature such as about room temperature to about 60° C., and specific current density (which may vary depending on the electrode size) such as one in the order of 50 A/m² to 800 A/m², using an inert anode such as titanium coated with mixed metal oxides and a cathode such as stainless steel.

Using electrochemical methods such as electrowinning, nickel and cobalt may be selectively deposited as metal or their alloy on one of the electrodes. In various embodiments, manganese does not deposit on the electrode(s), and the alloy may only be nickel and cobalt, i.e. manganese free, and can be used for various alloy applications.

In order that the invention may be readily understood and put into practical effect, particular embodiments will now be described by way of the following non-limiting examples.

### EXAMPLES

A method disclosed herein may be directed to obtain sulphate salts of mixed nickel, manganese, and cobalt in a usable form for battery cathode manufacturing. As disclosed herein, methods may relate to nickel-rich sulphate recovery from Li-ion battery waste black mass leachate. The obtained recipe to get Tutton salt may be improved further in terms of the recovery rate and the purity. Beyond these two features, it has been shown herein that the final product can again be converted to conventional hydrate sulphate crystals, which may be directly usable in battery cathode manufacturing.

The Tutton double sulphate salts, when compared to the conventional sulphate salts of nickel cobalt manganese, are much less soluble in water. As a result of lower solubility, the metals, such as nickel cobalt manganese, can be easily precipitated or crystallized out as solid from a leachate containing all the metal ions and thus the recovery rates for nickel cobalt manganese metals may be high.

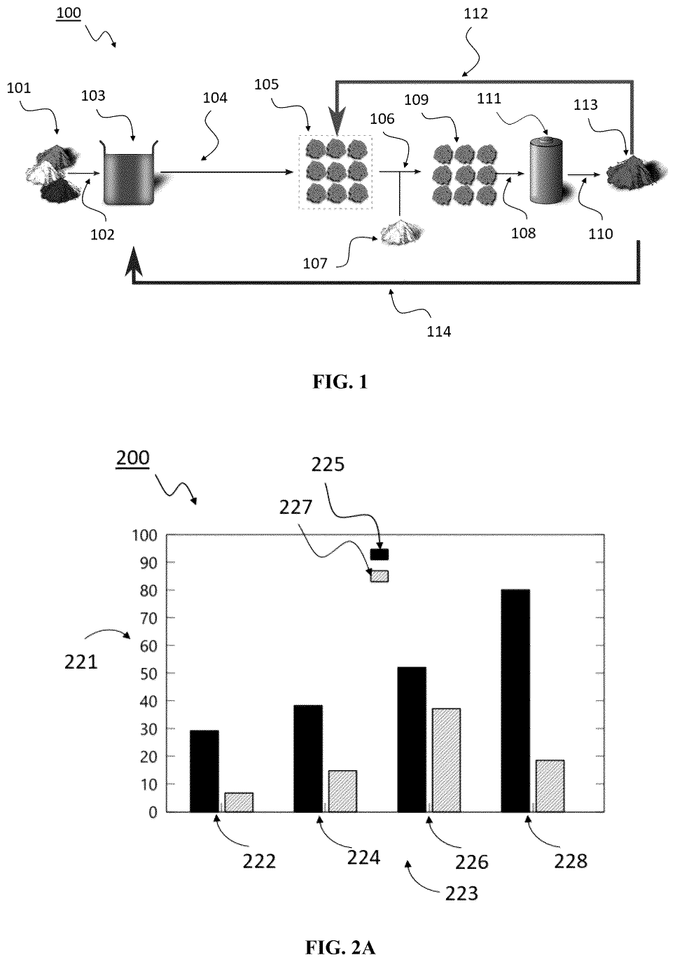

FIG. 1 is a schematic diagram illustrating a process 100 for manufacturing lithium-ion batteries and recycling Ni, Mn, and Co metals from spent lithium batteries. Sulphate salts of Ni, Mn and Co 101 are dissolved in water at step 102 to form a mixed sulphate solution 103. Controlled synthesis and battery performance determining is carried out at step 104 to prepare Ni/Mn/Co coprecipitate particles 105. Calcination of the Ni/Mn/Co coprecipitate particles 105 is carried out at step 106, with addition of lithium salt 107, to form a cathode material 109. The cathode material 109 may be processed at step 108 for manufacturing battery 111. Following usage of the battery 111 at step 110, the spent lithium ion batteries may turn into battery waste in the form of a black mass 113, and may be recycled using a precipitation method 112, such as precipitation of their oxalate/carbonates or hydroxides to give insoluble co-precipitates, for regenerating as Ni/Mn/Co coprecipitate particles 105. Methods 114 involving solvent extraction coupled with crystallization can give sulphate salts/mixed sulphate salts and regenerating as mixed sulphate solution 103 for battery cathode manufacturing.

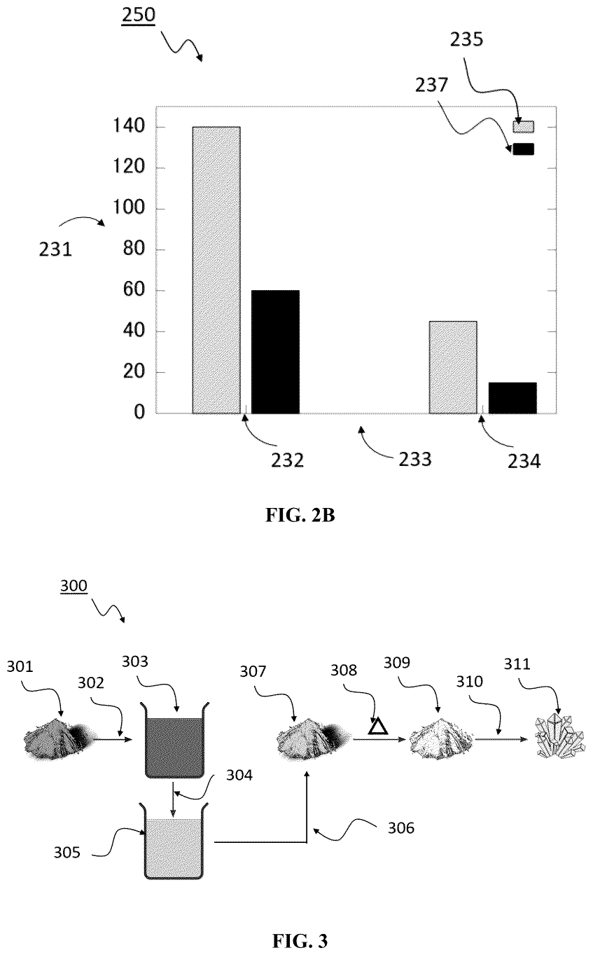

The solubility trends for the system is shown in FIG. 2A. Notably, for Ni, solubilities of the double sulphate salt with conventional sulphates in water and sulphuric acid medium were compared as shown in FIG. 2B. Solubility in sulphuric acid medium declines even further for both the conventional sulphates or the double salt (Tutton salt). Similar trend also holds true for Mn and Co. In other words, obtaining nickel, manganese and cobalt from the leachate may be enhanced in an acidic medium. Therefore, the double sulphate salt can be precipitated or crystallized out easily in sulphuric acid medium.

Two cases might arise in this regard: 1) when the leachate already contains sulphate ion. This is most likely the case when leaching is carried out in sulphuric acid medium. 2) If the leachate is done in some other medium and the solution does not contain sulphate ions to begin with, then sulphuric acid can be added after the leaching process is done to increase the sulphuric acid concentration in the solution and to bring the system to slightly acidic pH. Once enough sulphuric acid is present in the solution, the double sulphate salts can be precipitated easily.

An overview of the recipe is shown in FIG. 3 to briefly go through the process. Battery waste or black mass 301 is subjected to an acid leach process 302 to obtain a leachate (raw) 303. The leachate (raw) 303 obtained after acid leaching 302 comprises a mixture of undissolved materials, such as anode graphite, and a dissolved solution containing valuable elements such as nickel, cobalt, manganese, and other “unwanted metals” such as lithium (Li), aluminum (Al), and iron (Fe). The leachate (raw) 303 is subjected to a filtration step 304 to remove the undissolved materials, thereby yielding a clear solution leachate 305 enriched with the valuable elements. The clear solution leachate 305 is then contacted with a reagent comprising ammonium ions at step 306 to precipitate metal ions as a double salt precipitate 307. The “unwanted metals” such as Li may be recovered separately. The double salt precipitate 307 is heated at step 308 to form an anhydrous sulphate 309. The anhydrous sulphate 309 is dissolved in a solution comprising sulphate ions and crystallization is carried out at step 310 to form hydrated sulphate crystals 311.

In exemplary embodiments, black mass was leached in sulphuric acid to give raw leachate which contained valuable metals such as nickel, cobalt, manganese, and other unwanted metals such as lithium, aluminum and iron. To this leachate, ammonium sulphate was added as the precipitating agent. When the solution was saturated with enough ammonium sulphate salt, a bluish green salt was precipitated out from the solution, which when dried, gave a blue green salt solid. This salt was then annealed at temperatures around 400° C. for roughly 8 hours to get anhydrous yellow color looking powder. This yellow color looking powder was dissolved again in small amounts of dilute sulphuric acid and then recrystallize again to get hydrated mixed sulphate crystals of nickel, cobalt and manganese.

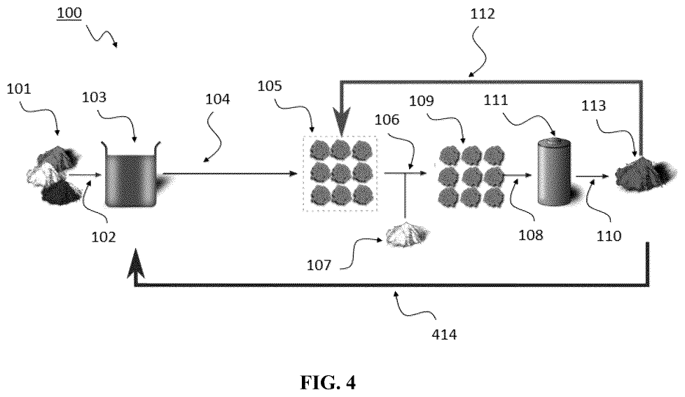

The above-mentioned recipe is able to provide mixed sulphate crystals of nickel, cobalt and manganese. In the context of recycling, Ni, Mn and Co for battery cathode manufacturing, a product which is one step before the most crucial step of battery cathode synthesis may be obtained, as shown in FIG. 4. FIG. 4 is a schematic diagram depicting a process 100 of making lithium ion batteries and recycling Ni/Mn/Co metals in spent lithium ion batteries, reproduced from FIG. 1. The double salt recovery route according to embodiments disclosed herein replaces method 114 and is shown as 414 in the figure. Comparison is made between end product of a precipitation method 112 of Ni/Mn/Co coprecipitate particles 105, and end product of presently disclosed double salt sulphate recovery route 414 of mixed sulphate solution 103. Depending on the metal composition needed and other requirements such as the right particle size distribution, tap density, and homogeneity, the reaction can be controlled as needed to get the right NMC ratio with the right characteristics.

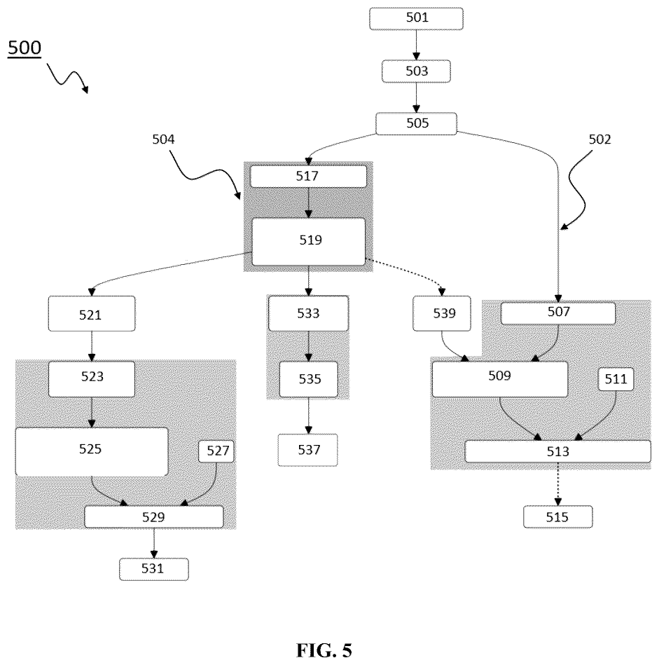

FIG. 5 is a flow diagram 500 comparing a double salt sulphate recovery route 504 disclosed herein with a conventional precipitation recipe route 502. The flow chart in FIG. 5 shows the various processes possible from metal recovery of nickel, manganese and cobalt from an impure leachate. Black mass powder 501 is subjected to acid leaching 503 to form impure leachate 505. In convention precipitation recipe route 502, the impure leachate 505 is subjected to pH increase purification 507 for subsequent oxalate/carbonate Ni—Mn—Co resynthesis/regeneration 509 to form Ni—Mn—Co oxalate/carbonate precipitate 513. Li salt 511 is added to the Ni—Mn—Co oxalate/carbonate precipitate 513 to form NMC cathode 515. In double salt sulphate recovery route 504, the impure leachate 505 is subjected to Tutton salt precipitation 517, and subsequent crystallization to form Ni/Co/Mn mixed sulphate crystals (Ni—Mn—Co purity 95%) 519. The Ni/Co/Mn mixed sulphate crystals (Ni—Mn—Co purity 95%) 519 may undergo industrial/commercial route 521, to form Ni—Co—Mn sulphate solution 523. Controlled hydroxide co-precipitation in continuous stirred tank reactor 525 is carried out to form Ni—Mn—Co hydroxide particles 529. Li salt 527 is added to the Ni—Mn—Co hydroxide particles 529 to form NMC cathode 531. The Ni/Co/Mn mixed sulphate crystals (Ni—Mn—Co purity 95%) 519 may alternatively undergo electrochemical methods 533, to form Ni—Co alloy (Mn free) 535 which may be used for alloy applications 537. One thing to note here is that the conventional precipitation method directly gives the product as oxalate carbonate or hydroxide form, which in fact is the regenerated product going into NMC cathode manufacturing. However, this step combines the recovery of Ni, Mn and Co with the re-synthesis of nickel manganese cobalt as their co-precipitate. Because it is a two-in-one step, the recovery rates and the precipitate quality cannot be controlled simultaneously in this two-in-one step. Conventional precipitation processes, if targeting high recovery rates as in the case with oxalates, the particle size and particle size distribution are not well suited. Although hydroxide precipitation may provide the best particle size, particle size distribution and density amongst conventional precipitation processes, controlling the impurity, recovery rates and other factors however, becomes very challenging straight from leachate as it involves oxygen (O₂)-free synthesis conditions.

In contrast to conventional precipitation process which is two-in-one recovery-regeneration combined, presently disclosed method separates the recovery and regeneration into two discrete steps, giving more control on maximizing the recovery rates (recovery step) and also the regenerated product quality (regeneration or recycling step). Present method when resulting in mixed sulphate crystals (recovery step), these crystals can be recycled (recycling step) in three different ways as shown in FIG. 5. One way is to go through industrial route where nickel cobalt manganese sulphate crystals are mixed to form a sulphate solution which is then fed into continuous stirred tank reactor (CSTR). This argon gas filled reactor is then also fed with liquid ammonia and sodium hydroxide at a very controlled rate to get the nickel cobalt manganese hydroxide particles with the needed particle size, distribution and density and homogeneity and so on. Hence, the sulphate crystals can be used using this technique at large scale to produce industry grade MMC cathode.

Another way is to use the sulphate crystals to regenerate NMC cathode using oxalate or carbonate route, which may be carried out at small scale in laboratory when complex reactor such as continuous stirred tank reactor setup is not present. This follows the same procedure for conventional precipitation to demonstrate the use of recovered mixed sulphate crystals as making NMC cathode.

For example, stoichiometrically adjusted quantities of crystallized metal sulfate hexahydrates MSO₄·6H₂O may first be dissolved in deionized water to obtain a homogeneous aqueous solution containing Ni²⁺, Co²⁺, and Mn²⁺ ions. Subsequently, a precipitating agent such as ammonium oxalate or ammonium carbonate may be slowly added under continuous stirring. The precipitation may be carried out at room temperature or slightly elevated temperatures (such as 40° C. to 60° C.), and the pH may be controlled in the range of 7 to 9 for carbonate precipitation and 4 to 6 for oxalate precipitation. The solution may be stirred for several hours to ensure complete reaction and uniform particle growth. During this step, a co-precipitation reaction may occur, leading to formation of a nickel cobalt manganese oxalate/carbonate precipitate.

Yet another method may be to convert Ni—Mn—Co sulphate crystals to an alloy without Mn. The mixed sulphate crystals can also be dissolved again in water to get the mixed sulphate solution. Using electrochemical methods such as electrowinning, nickel and cobalt may be selectively deposited as metal or their alloy on one of the electrodes. In this case no manganese will deposit on this electrode, and the alloy will be only nickel and cobalt, i.e., manganese free. This nickel and cobalt alloy can be used for various alloy applications. The list of all alloys containing both nickel and cobalt is given in TABLE 1 below.

TABLE 1
Applications of alloys containing both Ni and Co

| Alloy code | Composition in wt % | Properties | Application |
|---|---|---|---|
| N06617, | NiCr23Co12Mo | A cobalt-containing alloy | aerospace. thermal |
| alloy 617, | (this means Cr 23 wt %, | with an exceptional | processing. high |
| inconel 617 | Co 12 wt %.) | combination of high | temperature |
| | | temperature strength, | strength and creep |
| | | stability, and oxidation | resistance |
| | | resistance. Also resistant | |
| | | to carburizing gases and a | |
| | | range of aqueous | |
| | | environments, it is used in | |
| | | petrochemical and thermal | |
| | | processing, nitric acid | |
| | | production, and gas | |
| | | turbine engineering | |
| N07001, | NiCr19Co14Mo4Ti | age hardened high | aerospace, turbine |
| Waspaloy | (this means Cr 19 wt %, | temperature strength | disk |
| | Co 14 wt %, Mo 4 wt %.) | | |
| Allcorr | Ni—(27-33)Cr—12Co—(8-12)Mo - | high pitting resistance in | deep sour gas |
| N06110 | others | chloride medium | wells, flue gas |
| | (this means Cr 27 to | | desulfurization |
| | 33 wt %, Co 12 wt %, Mo | | |
| | 8 to 12 wt %.) | | |
| Haynes HR- | Ni—(26-30)Cr—3.5Fe—(27-33)Co- | wrought superalloy, | industrial and |
| 160, N12160 | others | nitridization resistance | nuclear waste |
| | (this means Cr 26 to | | incinerators |
| | 30 wt %, Fe 3.5 wt %, Co | | |
| | 27 to 33 wt %.) | | |
| Lewmet 55, | 33Ni—16Fe—32Cr—4Mo—3Cu—6Co - | cast corrosion resistance | hot concentrated |
| | others | Nickel based alloy | H₂SO₄ service such |
| | (this means Ni 33 wt %, | | as pump impeller |
| | Fe 16 wt %, Cr 32 wt %, | | |
| | Mo 4 wt %, Cu 3 wt %, Co | | |
| | 6 wt %.) | | |
| Lewmet 66 | 37Ni—16Fe—31Cr—3Cu—6Co - | | dilute H₂SO₄ |
| | others | | nozzles |
| | (this means Ni 37 wt %, | | |
| | Fe 16 wt %, Cr 31 wt %, | | |
| | Cu 3 wt %, Co 6 wt %.) | | |
| Nimonic90 | NiCr20Co18Ti | Creep resistant | aerospace |
| | (this means Cr 20 wt %, | superalloys | |
| | Co 18 wt %.) | | |
| Nimonic 105 | NiCo20Cr15MoAlTi | | aerospace |
| | (this means Co 20 wt %, | | |
| | Cr 15 wt %.) | | |
| | Ni28Co23 | | ceramic to metal |
| | (this means Ni 28 wt %, | | seal |
| | Co 23 wt %.) | | |
| AlloyPK33 | NiCr18Co14Mo7AlTi | resistant to thermal shock | combustion |
| | (this means Cr 18 wt %, | and thermal fatigue | chambers, jet pipes |
| | Co 14 wt %, Mo 7 wt %.) | | for turbine engines |
| | Ni29Co18 (46 to 47 Fe, | | glass to metal seal |
| | rest others) | | for borosilicate |
| | | | glass, unlike other |
| Alloy code | Composition in wt % | Properties | Application |
| | (this means Ni 29 wt %, | | metals addition of |
| | Co 18 wt %, Fe 46 to | | Co reduces the |
| | 47 wt %.) | | thermal expansion |
| | | | coefficient at room |
| | | | temp |
| Udimet 700 | Ni73—19.5Cr—13.5Co—4.3Mo—3Ti - | excellent fatigue crack | disk blade in gas |
| | others | growth resistance | turbine engine |
| | (this means Ni 73 wt %, | | |
| | Cr 19.5 wt %, Co | | |
| | 13.5 wt %, Mo 4.3 wt %, | | |
| | Ti 3 wt %.) | | |
| Alloy739 | NiCr23Co19TiNb | | disk blade in gas |
| | (this means Cr 23 wt %, | | turbine engine |
| | Co 19 wt %.) | | |
| Alloy 263 | NiCo20Cr20MoTi | | disk blade in gas |
| | (this means Co 20 wt %, | | turbine engine |
| | Cr 20 wt %.) | | |
| | NiCr20Co18TiAl | | High temperature |
| | (this means Cr 20 wt %, | | corrosion resistance |
| | Co 18 wt %.) | | superalloys |
| | NiCr22Co19Nb | | High temperature |
| | (this means Cr 22 wt %, | | corrosion resistance |
| | Co 19 wt %.) | | superalloys |
| | NiCr25Co20TiAl | | High temperature |
| | (this means Cr 25 wt %, | | corrosion resistance |
| | Co 20 wt %.) | | superalloys |
| Rene 41 | 55Ni—19Cr—11Co—10Mo—3Ti | | |
| | others | | |
| | (this means Ni 55 wt %, | | |
| | Cr 19 wt %, Co 11 wt %, | | |
| | Mo 10 wt %, Ti 3 wt %.) | | |
| M252 | 56.5Ni—19Cr—10Co—10Mo—2.6Ti | | |
| | others | | |
| | (this means Ni | | |
| | 56.5 wt %, Cr 19 wt %, Co | | |
| | 10 wt %, Mo 10 wt %, Ti | | |
| | 2.6 wt %.) | | |
| K94610, | 29.5Ni—53Fe—17Co | glass sealing alloy for | |
| Kovar | (this means Ni | sealing borosilicate alloy | |
| | 29.5 wt %, Fe 53 wt %, Co | | |
| | 17 wt %.) | | |
| N07263, C- | 51Ni—36Fe—20Co—5.8Mo—20Cr - | Precipitation hardened | |
| 263 | others | alloy | |
| | (this means Ni 51 wt %, | | |
| | Fe 36 wt %, Co 20 wt %, | | |
| | Mo 5.8 wt %, Cr 20 wt %.) | | |
| N07090 | 60Ni—19Cr—16.5Co - | | |
| | others | | |
| | (this means Ni 60 wt %, | | |
| | Cr 19 wt %, Co | | |
| | 16.5 wt %.) | | |
| N19903 | 38Ni—41.5Fe—15Co - | | |
| | others | | |
| | (this means Ni 38 wt %, | | |
| | Fe 41.5 wt %, Co | | |
| | 15 wt %.) | | |
| Rene 95 | Ni—13Cr—3.5Mo—W3.5—8Co - | high temperature creep | aerospace |
| | others | resistance and low cycle | |
| | (this means Cr 13 wt %, | fatigue life | |
| | Mo 3.5 wt %, W 3.5 wt %, | | |
| | Co 8 wt %.) | | |
| IN 100 | 12.5Cr—3.2Mo—4.3Ti—18.5Co—5Al | high temperature creep | compressor and |
| | (this means Cr | resistance and low cycle | turbine disk |
| | 12.5 wt %, Mo 3.2 wt %, | fatigue life | material |
| | Ti 4.3 wt %, Co | | |
| | 18.5 wt %, Al 5 wt %.) | | |
| LC Astroloy | Ni—15Cr—5Mo—3.5Ti—17Co - | excellent ductility and | dual-alloy turbine |
| | others | high-temperature strength | disks as well as |
| | (this means Cr 15 wt %, | | one-piece hubs |
| | Mo 5 wt %, Ti 3.5 wt %, | | with inserted |
| | Co 17 wt %.) | | blades for aircraft |
| | | | auxiliary power |
| | | | units |
| N18 | Ni—11.5Cr—6.5Mo—4.3Ti—15.5Co - | high strength as well as | Alloy N18 is useful |
| | others | good creep resistance and | in both bore and |
| | (this means Cr | excellent creep fatigue | rim locations at |
| | 11.5 wt %, Mo 6.5 wt %, | crack growth behavior up | temperatures up to |
| | Ti 4.3 wt %, Co | to 650° C. | ~650° C. |
| | 15.5 wt %.) | | |
| Incoloy 903 | Fe—27.7Ni—16Co - | coefficient of thermal | gas turbine |
| | others | expansion, high strength | components |
| | (this means Ni | | |
| | 27.7 wt %, Co 16 wt %.) | | |
| MAR-M | Ni—8Cr—9Co—12W - | direction solidification | used for many |
| 200Hf, | others | casting | structural |
| MAR-M 002, | (this means Cr 8 wt %, | | applications that |
| MAR-M247 | Co 9 wt %, W 12 wt %.) | | require ultrahigh |
| | | | strength and high |
| | | | fracture toughness |
| Aerex 350 | 44.5Ni—17Cr—25Co - | cast polycrystalline alloy | fastener material |
| | others | | for gas turbine |
| | (this means Ni | | engines |
| | 44.5 wt %, Cr 17 wt %, Co | | |
| | 25 wt %.) | | |
| MAR-M 200 | 59Ni—9Cr—10Co - | cast polycrystalline alloy | gas turbine |
| | others | | components, jet |
| | (this means Ni 59 wt %, | | engine blades |
| | Cr 9 wt %, Co 10 wt %.) | | |
| Inconel 100 | 60.5Ni—10Cr—15Co—3Mo—5.5 Al- | cast polycrystalline alloy | aerospace |
| | others | | |
| | (this means Ni | | |
| | 60.5 wt %, Cr 10 wt %, Co | | |
| | 15 wt %, Mo 3 wt %, Al | | |
| | 5.5 wt %.) | | |
| Refractaloy | Ni—18Cr—38Ni—20Co—16Fe—3.2 Mo - | precipitation hardened | |
| 26 | others | alloy | |
| | (this means Cr 18 wt %, | | |
| | Ni 38 wt %, Co 20 wt %, | | |
| | Fe 16 wt %, Mo 3.2 wt %.) | | |
| Alloy N-155 | 21Cr—20Ni—20Co—3Mo—32Fe - | wrought superalloy | aircraft gas turbines |
| Multimet, | others | | |
| R30155 | (this means Cr 21wt %, | | |
| | Ni 20 wt %, Co 20 wt %, | | |
| | Mo 3 wt %, Fe 32 wt %.) | | |
| Haynes 556, | 22Cr—21Ni—20Co—3Mo—29Fe - | wrought superalloy | sulfidation |
| R30556 | others | | resistance used in |
| | (this means Cr 22 wt %, | | sulphur bearing |
| | Ni 21 wt %, Co 20 wt %, | | environment |
| | Mo 3wt %, Fe 29wt %.) | | |
| Rene N6 | 4.2Cr—12.5Co—7.2Ta—5.4Fe - | single crystal casting | |
| | others | | |
| | (this means Cr 4.2wt %, | | |
| | Co 12.5 wt %, Ta | | |
| | 7.2 wt %, Fe 5.4 wt %.) | | |
| SC 180 | Ni—5Cr—10Co—8.5Ta—5.2Al - | single crustal casting | |
| | others | | |
| | (this means Cr 5 wt %, | | |
| | Co 10 wt %, Ta 8.5 wt %, | | |
| | Al 5.2 wt %.) | | |
| CSS-42L and | 12Cr—2Ni—4.7Mo—12.5Co— | carburizing martensitic | bearing and gear, |
| pyrowear | (this means Cr 12 wt %, | stainless steel | hydraulic turbine |
| stainless | Ni 2 wt %, Mo 4.7 wt %, | | repair in electric |
| steels | Co 12.5 wt %.) | | power plants |
| Aermet 100 | 2.4Cr—11.5Ni—13.4Co | high fracture toughness | landing gear |
| | (this means Cr 2.4 wt %, | steels, high strength to | components, |
| | Ni 11.5 wt %, Co | density ratio steels | hooks, fasteners, jet |
| | 13.4 wt %.) | | engine shafts |
| AlniCo | 10Al—19Co—13Co—3Cu | | magnets |
| | (this means Al 10 wt %, | | |
| | Co 19 wt %, Co 13 wt %, | | |
| | Cu 3 wt %.) | | |
| Rene 88DT | Ni—16Cr—4Mo—4W—3.7Ti—13Co - | | |
| | others | | |
| | (this means Cr 16 wt %, | | |
| | Mo 4 wt %, W 4 wt %, Ti | | |
| | 3.7 wt %, Co 13 wt %.) | | |
| B-1900 | 64Ni—8Cr—10Co—6Mo - | cast polycrystalline alloy | |
| | others | | |
| | (this means Ni 64 wt %, | | |
| | Cr 8 wt %, Co 10 wt %, | | |
| | Mo 6 wt %.) | | |
| Pyromet | 37.7Ni 16Co—39Fe- | precipitation hardened | |
| CTX-1 | others | superalloy | |
| | (this means Ni | | |
| | 37.7 wt %, Co 16 wt %, Fe | | |
| | 39 wt %.) | | |

TABLE 2
Metal concentration in the black mass
powder and in the acid leachate

| | Black mass | Leachate metal |
|---|---|---|
| Metal | powder wt % | conc. g/L |
| Ni | 21.41 | 4.66 |
| Mn | 6.03 | 1.41 |
| Co | 5.52 | 1.30 |
| Li | 3.47 | 0.993 |
| --impurities-- | | |
| Al | 1.19 | 0.09 |
| Cu | 0.08 | 0.02 |
| Fe | 0.1 | 0.04 |

An exemplary embodiment of the black mass used is shown in TABLE 2 with the metal wt % in the black mass. This black mass was leached using 3M H₂SO₄ and 4 vol % H₂O₂. The leachate was filtered out and the black mass slurry density or the solid to liquid ratio was kept between 25 to 40 grams per liter. After the leaching, the solution contained various metal ions in the solution as shown in TABLE 2 above. This acid leachate was then used to recover metals by precipitation of Tutton salt or double sulphate salt.

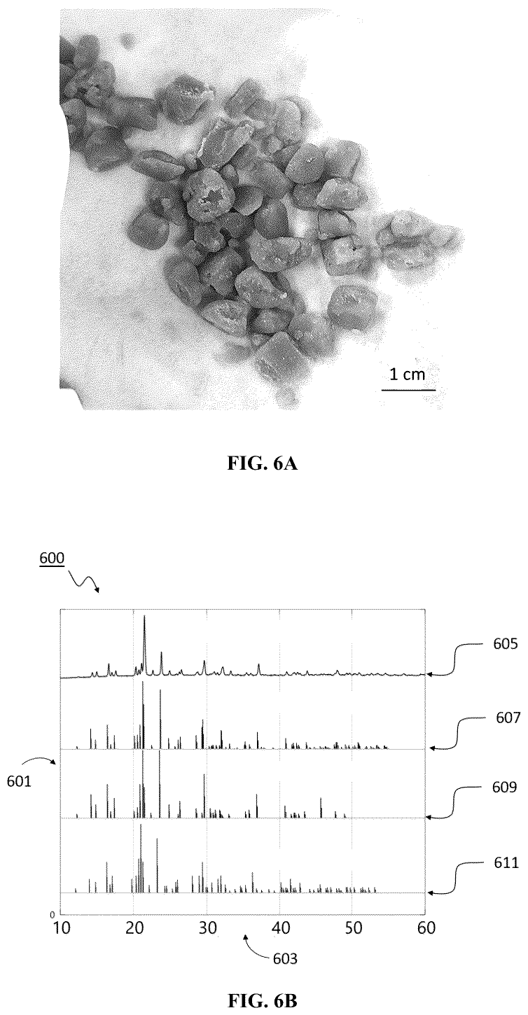

To precipitate the Tutton/double sulphate salt, commercial ammonium sulphate salt (Sigma Aldrich) was added with roughly the concentration of roughly 0.4 g in 1 mL of this leachate solution at room temperature and ambient conditions. The solution turned cloudy blue in color after about 15 minutes of stirring. After that, the solution stirring can be stopped and a blue precipitate settled at the bottom of the beaker. This blue precipitate was filtered from the liquid by centrifugation (FIG. 6A). This blue precipitate was scanned using X-ray diffraction and the pattern was compared with the Tutton salt of Ni, Mn and Co from the literature. The pattern peaks matched very well with the pattern for Ni and or Co as can be seen from FIG. 6B.

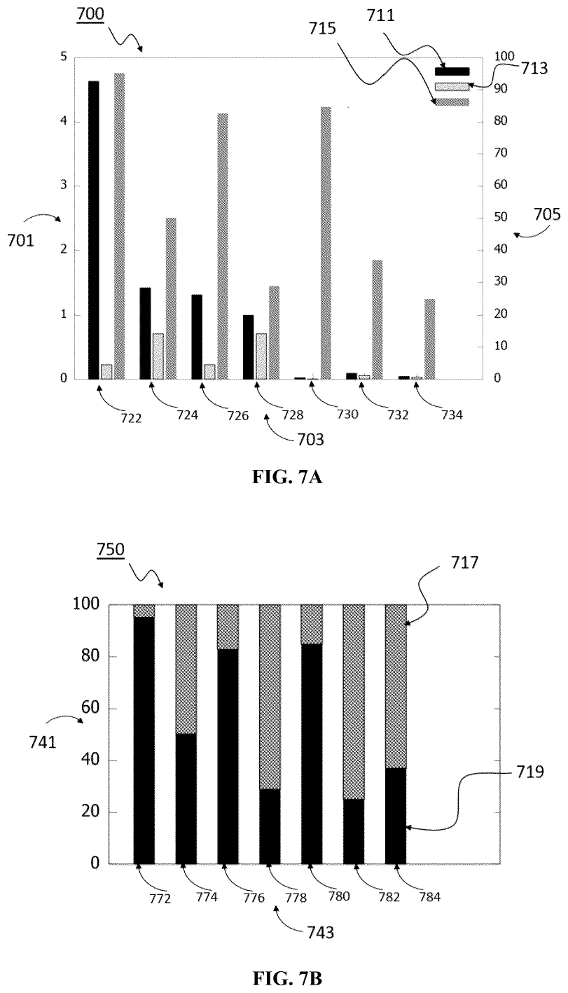

During this double salt precipitation process, the recovery or crystallization rate of the metals using ICP were also checked. Metal ion concentration in the solution before and after the double salt precipitation process were measured, which are plotted in FIG. 7A. Differences in the metal concentration provide recovery rates for the double salt process. From the results obtained, it can be seen that the recovery rates for nickel, manganese and cobalt are very high. The recovery rate for nickel reaches 95% followed by 80% for Co and 50% for Mn. One good thing to note here is that, Al and Fe do not form the double salt as they are usually trivalent ions in the solution, in view that double salts are formed only with divalent cations. Li also does not precipitate out much as Li is too small a monovalent cation in size to replace ammonia in the double salt. The exact values are also shown in TABLE 3 below.

TABLE 3
Tutton salt (Double salt sulphate) crystallization rates and
the metal ions concentration before/after crystallization

| | Metal | Ni | Co | Mn | Cu | Al | Fe | Li |
|---|---|---|---|---|---|---|---|---|
| Leachate | Before g/L | 4.66 | 1.30 | 1.41 | 0.02 | 1.09 | 0.04 | 0.99 |
| (liquid) | After g/L | 0.22 | 0.23 | 0.70 | 0.003 | 1.05 | 0.03 | 0.71 |
| Solid | % crystallized | 95.2 | 82.7 | 50.1 | 84.7 | 36.9 | 25 | 28.8 |
| | Wt % | 11.7 | 1.2 | 0.39 | 0.14 | 0.05 | 0.08 | 0.01 |

If rough distribution of all the metals during the double salt process based on the metal concentration in the solution before and after the precipitation and calculate the percentages were estimated (FIG. 7B), it can be seen that most of the Ni and Co from the starting solution ended up in the solid phase. The leftover solution or raffinate mostly contained Li, Al and Fe. Mn was half present in the solution and the other half went in the solid phase. Hence, it was also noted that Mn content was much reduced in the final solid phase compared to what was started with in the leachate. The Mn: Ni ratio in leachate was 0.303 and, in the precipitate, was about 0.033. This was almost 10 times decrease in the Mn content. With a reduced Mn content in the precipitate product, making NMC Ni rich compounds such as NMC 622 or 811 is expected to be much easier.

Notably, as shown with the high recovery rates of Cu, Cu can also fully precipitate as double salt in the solid. That is because copper chemically is very similar to Ni, Mn and Co informing double salt (FIG. 2A). So, in theory, if the copper amount is high, then the obtained double salts may be of lesser purity. In such instances, methods disclosed herein may involve removing of copper before the double salt precipitation is carried out. Copper may be easily removed by cementation by adding metal powder/metal foil of any of these metals Al, Fe, Co or Ni. Any of these metal powder or foil will selectively displace copper and these metal powder will be dissolved in the solution forcing the copper to precipitate out as a metallic form which can be filtered out. Hence, this cementation process can reduce the copper amount from the solution before the double salt precipitation is carried out.

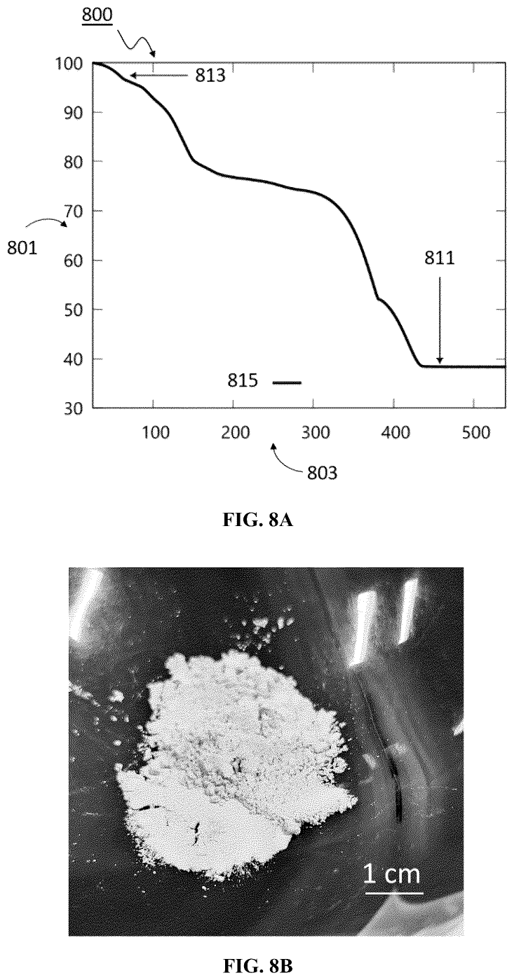

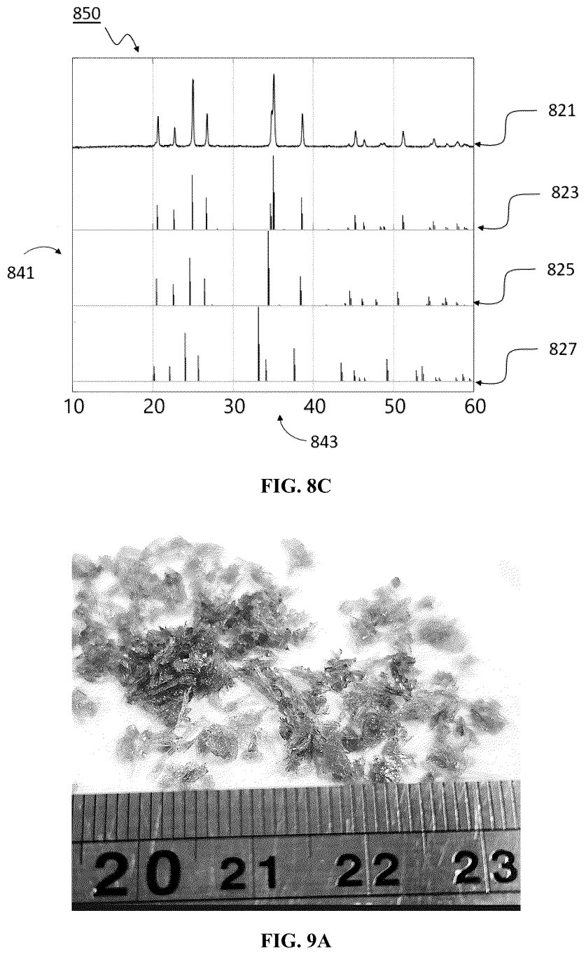

Once the double sulphate salt is obtained, the next goal is to remove the ammonium sulphate part from this double salt as it is not desired in the battery cathode manufacturing. This can be easily done by simple heating at temperatures above or around 400° C. as shown in the Thermogravimetric Analysis data in FIG. 8A. When the sample was heated at around 400° C. for about 8 hours, the blue crystal precipitate was converted into very fine yellow color powder as shown in FIG. 8B. This powder when scanned using X-ray diffraction matches with the X-ray diffraction peak of anhydrous NiSO₄ or CoSO₄ and thus it may be concluded that the salt was mostly converted into anhydrous sulphates of nickel, cobalt. Notably, as Mn contents were low in the sample, the solid product contained negligible amounts of MnSO₄ peaks.

Doing ICP and or Wavelength Dispersive X-Ray Fluorescence Spectroscopy (WDXRF) analysis for this yellow powder for purity analysis, the following results as shown in TABLE 4 were obtained. It can be seen that the powder contained mostly nickel followed by Co and Mn. The combined purity of Ni, Mn and Co was more than 95%.

TABLE 4
Yellow powder or calcined anhydrous sulphate
metal composition and purity determination

| | | Transition Metal |
|---|---|---|
| Metal | wt % | Purity % |
| Ni | 28.586 | 75.37 |
| Co | 5.6229 | 14.82 |
| Mn | 1.9755 | 5.2 |
| Ni + Mn + Co | 36.18 | 95.4 |
| Li | 0.09 | — |
| Cu | 0.0744 | — |
| Fe | 0.035 | — |
| Al | 0.09108 | — |
| Impurities combined | 0.28 | <5 |

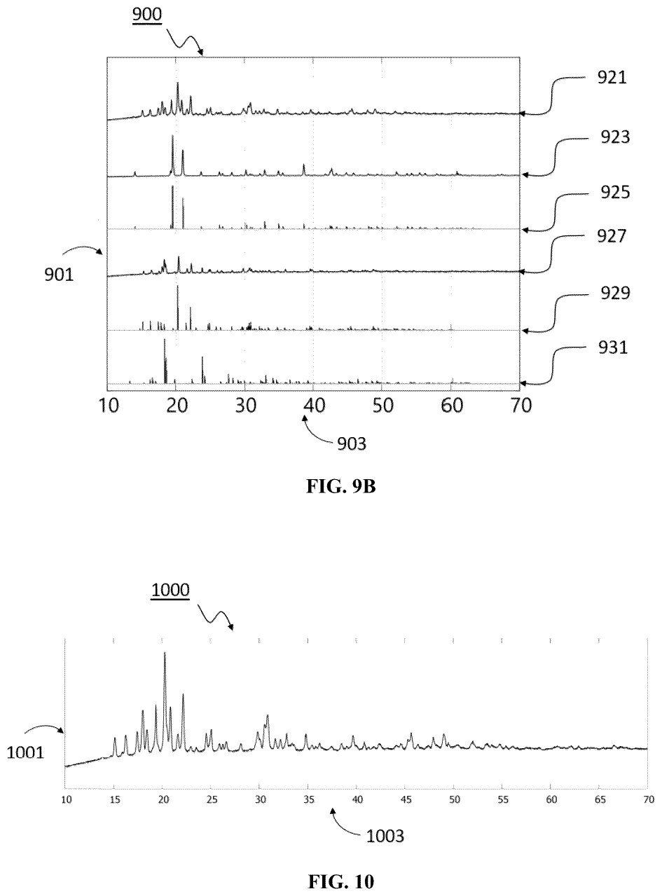

This yellow powder was dissolved in 0.2 M sulphuric acid to obtain a solution with a pale green color. The ratio of yellow powder to sulphuric acid was used to keep the molar concentration of metal salt to 2 M and sulphuric acid 0.2 M respectively. The dissolved pale green solution was transferred to a petri dish and placed in the fumehood covered with a tissue paper to crystallize a salt out. After almost 1 day, blueish green crystals began to crystalize out leaving a very little amount of liquid in the petri dish. The crystals were picked off and dried using tissue paper. These crystals were then scanned using XRD to obtain fingerprint of the sample (FIG. 9A). As a comparison, the final product was also compared with the commercial NiSO₄ and CoSO₄ salts from Sigma Aldrich and shown in FIG. 9B.

From the data, it can be seen that the crystals obtained was a mixture of NiSO₄·6H₂O and CoSO₄·6H₂O. Since the manganese content is very low, the manganese sulphate peaks were very low to be detected in x-ray diffraction. The fingerprint is also shown in FIG. 10 for the final product obtained.

Comparison of this recipe was shown with conventional precipitation method using oxalate or carbonate and the solvent extraction and crystallization method in TABLE 5.

TABLE 5
Comparison of this work in various factors to conventional
oxalate/carbonate precipitation route and solvent

| | Solvent | | Double (Tutton) salt |
|---|---|---|---|
| | Extraction & | Oxalate/Carbonate | precipitation/ |
| Method | crystallization | precipitation | crystallization |
| Ni, Mn, Co | >98% | 65 to 80% | >95% |
| combined | | | |
| Purity % | | | |
| Recovery | >90 | >98 | 95 (Ni), 80 (Co), |
| rates % | | | 50 (Mn) |
| Temp needed | about 0-25 | Room temp | Room temp, 380 |
| in ° C. | | | |
| Reagents | CYNEX 272, | Amm. Oxalate, | Amm. Sulphate |
| | PC88A | Amm. Carbonate, | (low cost) |
| | (expensive) | | |
| Installation | High | Low | Low |
| cost | | | |
| Product | Sulphates (pure, | Insoluble | Mixed hydrated |
| | mixed) | oxalates/carbonate | sulphates |

This comparison was done on various factors shown as rows. The double salt precipitation route can actually give a very good, combined purity of nickel, manganese and cobalt along with high recovery rates especially for nickel and cobalt with using very low cost reagents and a very simple recipe to obtain mixed sulphate hydrates. This, when compared with conventional precipitation route, gives insoluble oxalate carbonates or hydroxide as the final product which may not suit well with industry requirement for battery cathode manufacturing. Also, the purities may be compromised because precipitation is not very selective. Finally, solvent extraction followed by crystallization method has main drawback of very high installation cost and very costly reagents.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. A method of recovering metal from battery waste, the method comprising providing a battery waste leachate comprising metal ions and sulphate ions in an acidic medium;
contacting the battery waste leachate with a reagent comprising ammonium ions to precipitate the metal ions as a double sulphate salt having formula (NH₄)₂M(SO₄)₂·6H₂O, wherein M is one or more of Ni, Mn and Co;
heating the precipitate at a temperature of 400° C. or more to form an anhydrous precipitate;
dissolving the anhydrous precipitate in a solution comprising sulphate ions; and
crystallizing MSO₄·6H₂O from the resultant solution.

2. The method according to claim 1, wherein providing the battery waste leachate comprises contacting a battery waste with sulphuric acid to leach metal ions from the battery waste to form the battery waste leachate.

3. The method according to claim 2, wherein the sulphuric acid is provided with hydrogen peroxide.

4. The method according to claim 3, wherein a solid to liquid ratio of the battery waste with sulphuric acid and hydrogen peroxide is between 20 g/L to 150 g/L.

5. The method according to claim 1, wherein providing the battery waste leachate comprises contacting a battery waste with a leaching solution to leach metal ions from the battery waste to form a leachate comprising the metal ions, and adding sulphuric acid to the leachate to form the battery waste leachate.

6. The method according to claim 5, wherein the leaching solution is selected from the group consisting of bioleachate obtainable from a bioleaching process.

7. The method according to claim 1, wherein providing the battery waste leachate further comprises adding a cementation metal selected from the group consisting of aluminum, iron, cobalt, and nickel to the battery waste leachate, and filtering the resultant battery waste leachate to remove precipitate.

8. The method according to claim 1, wherein the reagent comprising ammonium ions is selected from the group consisting of ammonium sulphate, ammonium hydrogen sulphate, and ammonia solution.

9. The method according to claim 1, wherein the reagent comprising ammonium ions is ammonium sulphate, and the contacting is carried out with the ammonium sulphate at an atomic ratio of ammonium ion to metal ion in the range from 2:1 to 20:1.

10. The method according to claim 1, wherein heating the precipitate is carried out for 5 hours or more.

11. The method according to claim 1, wherein Ni, Co and Mn are present at 95 wt % or more of metal content in the anhydrous precipitate.

12. The method according to claim 1, wherein the solution comprising sulphate ions is dilute sulphuric acid.

13. The method according to claim 1, wherein the MSO₄·6H₂O comprises NiSO₄·6H₂O, CoSO₄·6H₂O and MnSO₄·6H₂O.

14. The method according to claim 1, wherein the method further comprises directly using the crystallized MSO₄·6H₂O in a process for manufacturing a battery cathode.

15. The method according to claim 14, wherein M is Ni, Mn and Co, and directly using the crystallized MSO₄·6H₂O comprises dissolving the crystallized MSO₄·6H₂O in water to form a mixed sulphate solution, and reacting the mixed sulphate solution with a precipitating agent to form a precipitate comprising Ni, M and Co.

16. The method according to claim 15, wherein the precipitating agent is a mixture of ammonia solution with sodium hydroxide, and reacting the mixed sulphate solution with the precipitating agent forms nickel cobalt manganese hydroxide particles.

17. The method according to claim 16, further comprising adding a lithium salt to the nickel cobalt manganese hydroxide particles to form a NMC cathode.

18. The method according to claim 15, wherein the precipitating agent is a mixture of ammonia solution with one or more of an oxalate salt and a carbonate salt, and reacting the mixed sulphate solution with the precipitating agent forms a precipitate comprising one or both of nickel cobalt manganese oxalate and nickel cobalt manganese carbonate.

19. The method according to claim 18, further comprising adding a lithium salt to the precipitate to form a NMC cathode.

20. The method according to claim 1, further comprising dissolving the crystallized MSO₄·6H₂O in water to form an electrolyte, and carrying out electrowinning on the electrolyte to deposit one or both of Ni and Co on an electrode.
